(19) United States
(12) Patent Application Publication
(10) Pub. No.: US 2014/0380506 A1
(43) Pub. Date: Dec. 25, 2014

(54) CONTROLLED DISTRIBUTION OF A VISUAL ASSET THAT INCLUDES IMAGES OF PARTICIPANTS

(71) Applicant: Ran Oz, Maccabim (IL)

(72) Inventor: Ran Oz, Maccabim (IL)

(21) Appl. No.: 13/938,309

(22) Filed: Jul. 10, 2013

Related U.S. Application Data
(60) Provisional application No. 61/838,286, filed on Jun. 23, 2013.

(51) Int. Cl. G06F 21/62

(52) U.S. Cl. CPC G06F 21/6218
USPC 726/28

(57) ABSTRACT

A system, method and a non-transitory compute readable medium for controlled distribution of a content of a visual asset that comprises an image of a participant, the method may include receiving a request to enable a certain viewer to receive the visual asset; selecting by a processor, in response to a characteristic of the certain viewer and in response to participant image access authorization metadata, a selected version of the visual asset to be provided to the certain viewer, out of a first version of the visual asset and a second version of the visual asset; wherein the first version of the visual asset comprises an identifiable image of the participant; wherein the second version of the visual asset comprises a non-identifiable image of the participant; wherein participant image access authorization metadata that allows access to the identifiable image of the participant requires an approval of the participant; and providing a response to the request that comprises the selected version of the visual asset.

### RELATED APPLICATIONS

This application claims priority from U.S. provisional patent Ser. No. 61/838,286 filing date Jun. 23, 2013 which is incorporated herein by reference.

### BACKGROUND OF THE INVENTION

During the last decade the social networks allowed people to upload and distribute pictures of other people. These other people can be damaged from this distribution of their pictures. The damage can occur instantly or even many years after these pictures have been uploaded and distributed.

There is a growing need to allow people to control the distribution of their pictures—especially pictures taken by other people.

### SUMMARY

A method, a system and a non-transitory computer readable medium are provided for controlled distribution of a visual asset owner by an owner, the visual asset includes an identifiable image of a participant and is requested to be viewed by a viewer.

Owner—the person which is the owner of the Album/Image. In many cases it the photographer of the assets (images/videos).

Participant—A person that participate in the visual asset. Was photographed in the Photo/video by the owner

Viewer—Someone that is viewing the visual assets according to the permissions of the asset at any given time.

Main use case for website.com:
Owner upload an Album to website.com
The software in the cloud is using face detection technology and with the Owner help (Prior art: Picassa, Face.com) the Participants in each photo are identified.
The full Album with the original images is only available for the Owner
For every photo, each appearance of a participant within this photo can be have one of the following 3 states:
   Noy-yet-approved (default)
   Approved
   Not-Approved
The following “Approval” process starts behind the scenes:
   All Participants in the Album are notified to approve their appearance in all photos (photo by photo)
   When a Participant view the Album they see their own face clearly (like in the original photo) but they do not see the faces of other Participants that are not yet approved their appearance.
   Participants start to approve or dis-approving their appearance in each photo
   Participate can also request the Owner to remove a photo altogether (it is up to the Owner to make the final call)
Although there is one Album, there are many displayed versions of that Album, all created in real-time based on who is looking and the approval process of the participants. The approvals can be changed at any time . . . .
Following the quick “Approval” process the owner can make a decision of each photos to remove
   Note: The photos may still include faces that were dis-approved and this is OK. This is part of the rules of website.com
Owner and Participants can share the Album with many other viewers
In each photo, viewers will see only faces of participants that were approved
At any given time, even after a few years, Participants can log in to website.com and change their approval.
At any given time, even after a few years, the Owner can log in and delete or un-delete or add photos to the Albums. New photos will go thru the same approval process.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates method according to an embodiment of the invention;

FIG. 2 illustrates a stage of the method of FIG. 1 according to an embodiment of the invention;

FIG. 3 illustrates a computerized system and various data structures according to an embodiment of the invention;

FIG. 4 illustrates method according to an embodiment of the invention; and

FIG. 5 illustrates method according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a processor result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a processor that reads the instructions stored in the non-transitory computer readable medium.

According to an embodiment of the invention there is provided a system, method and a non-transitory computer readable medium for a controlled distribution of a content of a visual asset.

The term visual asset may include one or more images. It may include one or more pictures, one or more drawings, one or more photographs, one or more video streams, one or more multimedia media stream, and the like.

The term image may refer to a photograph, picture, drawing and a combination thereof.

The term “owner” refers to the person that is the owner of the visual asset. It can be the entity that provided the visual asset. It may be, for example, the photographer that acquired the video asset.

The term “participant” is a person that participated in the visual asset—an image of the participant is included in the visual asset. The participants can control access to identifiable images of the participant and change the access authorization over time.

The term “viewer” is a person who wishes to view the visual asset. The system, method and computer readable medium will allow a viewer to receive a version of the visual asset that includes identifiable images of participants that authorized the viewer to view the visual asset with their identifiable images.

The term “image of a participant” refers to an image of the participant or of a part (for example the face) of the participant.

The term “identifiable image of a participant” refers to an image of the participant from which the identity of the participant can be learnt. It may be a clear image of the participant.

The term “non-identifiable image of a participant” refers to an image of the participant from which the identity of the participant cannot be learnt (or at least cannot be learnt from merely looking at the non-identifiable image of the participant). It may also be referred to as a masked image of the participant.

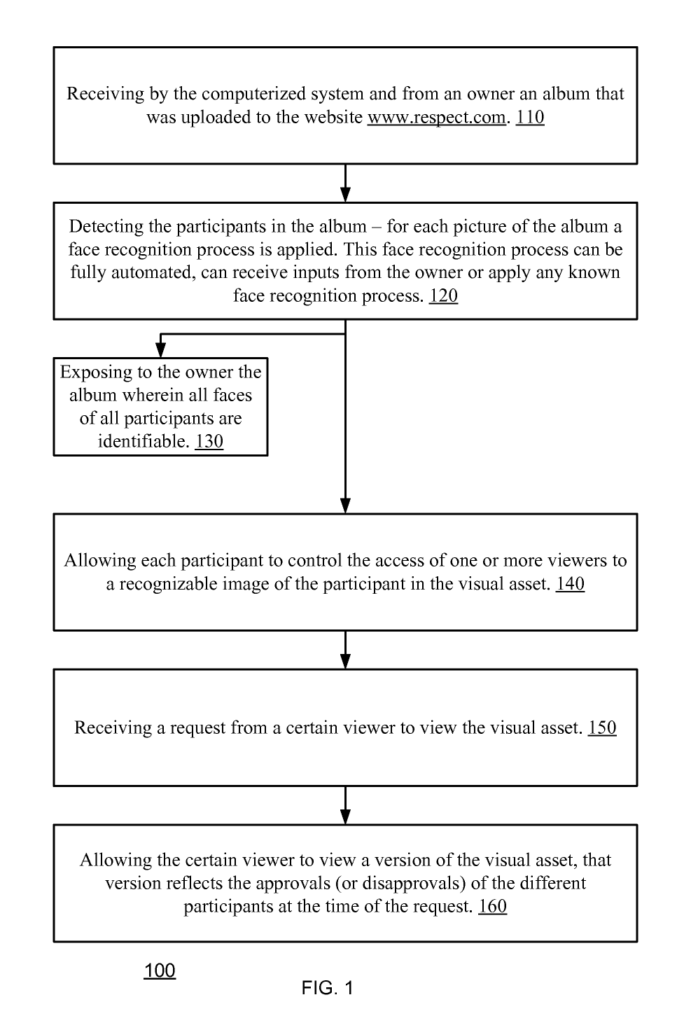

FIG. 1 illustrates method 100 according to an embodiment of the invention.

It is assumed that the visual asset is an album of pictures and that the storage of the album and that generation of versions of the album is executed by a computerized system that is located in a cloud computerized environment and that the computerized system can be accessed by a web site www.website.com.

Method 100 starts by stage 110 of receiving by the computerized system and from an owner an album that was uploaded to the website www.website.com.

Stage 110 is followed by stage 120 of detecting the participants in the album—for each picture of the album an image recognition (such as a face recognition) process is applied. This image recognition process can be fully automated, can include receiving inputs from the owner or apply any known image recognition process. It is assumed that at the end of stage 120 the participants of each picture of the album are recognized.

Stage 120 can be followed by stages 130 and 140.

Stage 130 may include exposing to the owner the album wherein all images of all participants are identifiable.

Stage 140 may include allowing each participant to control the access of one or more viewers to a recognizable image of the participant in the visual asset. The participant can determine which viewers (if any) can access which identifiable image of the participant. This determination can be made per each picture of the visual asset that conveys the image of the face of that participant. It is assumed that without an approval of the participant—access to an identifiable image of the participant will not be allowed. Thus—participant image access authorization metadata (that represents the determination of the participant) that allows access to the identifiable image of the participant requires an approval of the participant. As will be illustrated below- the participant can change his determination over time (even months and years after his first selection).

Stage 140 may be followed by stage 150 of receiving a request from a certain viewer (for example- by browsing to www.website.com) to view the visual asset.

Stage 150 is followed by stage 160 of allowing the certain viewer to view a version of the visual asset, that version reflects the approvals (or disapprovals) of the different participants at the time of the request.

Stage 160 may include converting an identifiable image of a participant to a non-identifiable image of the participant if the viewer should not receive the identifiable image of the participant—this can be done by masking, filtering, reducing the resolution of the identifiable image, or applying and manipulation process to generate the non-identifiable image of the participant.

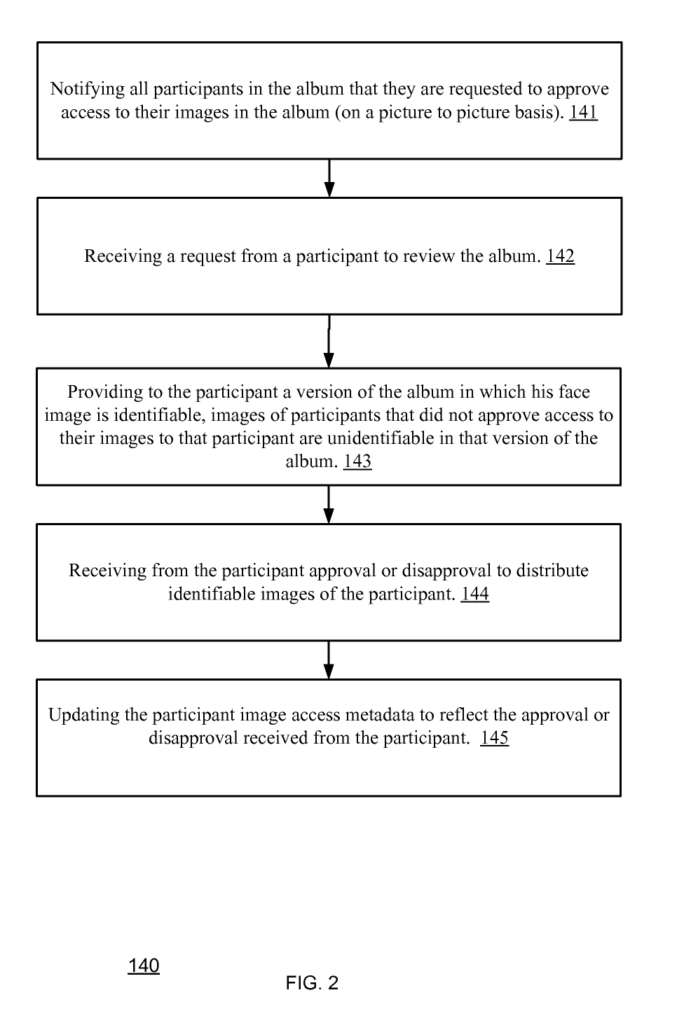

FIG. 2 illustrates stage 140 of method 100 according to an embodiment of the invention.

Stage 140 may starts by stage 141 of notifying all participants in the album that they are requested to approve access to their images in the album (on a picture to picture basis). Before receiving an approval an image of a participant can be set to a default “yet not approved”.

Stage 141 may be followed by stage 142 of receiving a request from a participant to review the album.

Stage 142 may be followed by stage 143 of providing to the participant a version of the album in which his image is identifiable, images of participants that did not approve access to their images to that participant are unidentifiable in that version of the album.

Stage 143 may be followed by stage 144 of receiving from the participant an approval or disapproval to distribute identifiable images of the participant. The approval can be aimed to any viewer, to certain viewers, to other participants, and the like. Stage 144 may include receiving a request from the participant to remove one or more pictures that includes images of the participant.

Stage 144 may be followed by stage 145 of updating the participant image access metadata to reflect the approval or disapproval received from the participant. Stage 145 may include removing one or more pictures from the album.

It is noted that a single album can be the source of many versions and that the different versions can be generated in real time in response to the identity of the viewer that requested to view the album and the participant image access metadata. The participant access metadata can be altered by participants at any time.

The execution of method 100 allows the owner and the participants to share the album with many other viewers. In each image, viewers can see only participants that were approved to be viewed by the participants. At any given time, even after a few years, participants can (log in to www.website.com) and change their approval.

At any given time, even after a few years, the owner can log in and delete or un-delete images of the visual asset or add images to the visual asset. New images will go through the same approval process.

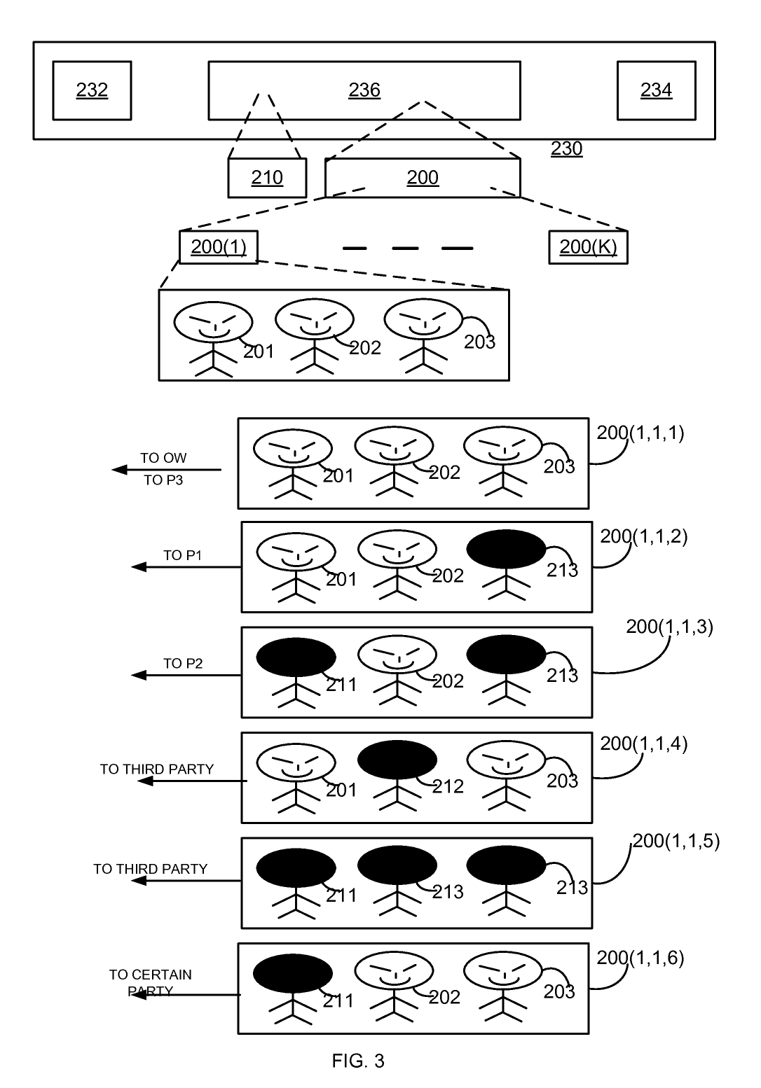

FIG. 3 illustrates a computerized system 230 and various data structures according to an embodiment of the invention. The computerized system 230 can be connected to computers of third parties, participants and owners via one or more networks such as the Internet.

Computerized system 230 may include an interface 232 and a processor 234. It may be positioned within a cloud computerized environment. The interface 232 may be a communication interface, a memory device and the like. The processor 234 may include one or more computing elements. The computerized system 230 can reside on one or more servers. The computerized system 230 can be accessed in various manner. For example it can be accessed by browsing to a web site such as www.resprct.com.

The data structures of FIG. 3 are illustrated as being stored in computerized system 230 and especially in memory module 236 of the computerized system.

These data structures include visual asset 200 and participant image access authorization metadata 210.

The visual asset 200 includes multiple (K) images 200(1)-200(K). The virtual asset 200 is owned by owner OW. At least some of these images can include images of participants. For example, image 200(1) includes identifiable images 201-203 of three participants P1-P3.

FIG. 3 and table 1 illustrate various versions of image 200(1,1). NA means not-relevant, NYA means not yet approved, NA means not approved, A means approved. The non-identifiable image of participants P1-P3 are denoted 211-213.

TABLE 1

| Version | Viewer | P1 | P2 | P3 |
|---|---|---|---|---|
| 200(1, 1, 1)-identifiable images of P1-P3- | OW | NA | NA | NA |
| 201, 202 and 203 | | | | |
| 200(1, 1, 2)-identifiable images of P1 and | P1 | NYA | A | NYA |
| P2 and non-identifiable image of P3- | | | | |
| 201, 202 and 213 | | | | |
| 200(1, 1, 3)-identifiable image of P2 and non- | P2 | NYA | A | NYA |
| identifiable images of P1 and P3- | | | | |
| 211, 202 and 213 | | | | |
| 200(1, 1, 1)-identifiable images of P1-P3- | P3 | A | A | NA |
| 201, 202 and 203 | | | | |
| 200(1, 1, 4)-non-identifiable image of P2 and | Third | A | NA | A |
| identifiable images of P1 and P3- | party | | | |
| 201, 212 and 203 | | | | |
| 200(1, 1, 5)-non-identifiable images of P1-P3- | Third | NA | NA | NA |
| 211-213 | party | | | |

For simplicity of explanation it is assumed that the approval does not differentiate between viewers that are not the owner of the visual asset—although the participant image access authorization metadata can differentiate between access rights of one third party to another and even may differentiate between other participants. For example, the participant image access authorization metadata may include NA(CTP)—not allowable for certain parties and NA(OP)- not allowable for other parties and table 1 may include the following columns:

| Version | Viewer | P1 | P2 | P3 |
|---|---|---|---|---|
| 200(1, 1, 6)-non-identifiable image of | Certain | NA(CTP) | A | NA |
| P1 and identifiable images of P2 and P3 | party | | | (OP) |

Yet for another example, a participant of a certain image (for example image 200(2)) can ask to remove that image from the visual asset 200 and the owner can approve or disapprove his request.

The participant image access authorization metadata 210 includes information about the access rights of viewers to each image of the participants within visual asset 200. The three rightmost columns of table 1 provide an example of the content of the participant image access authorization for image 200(1,1).

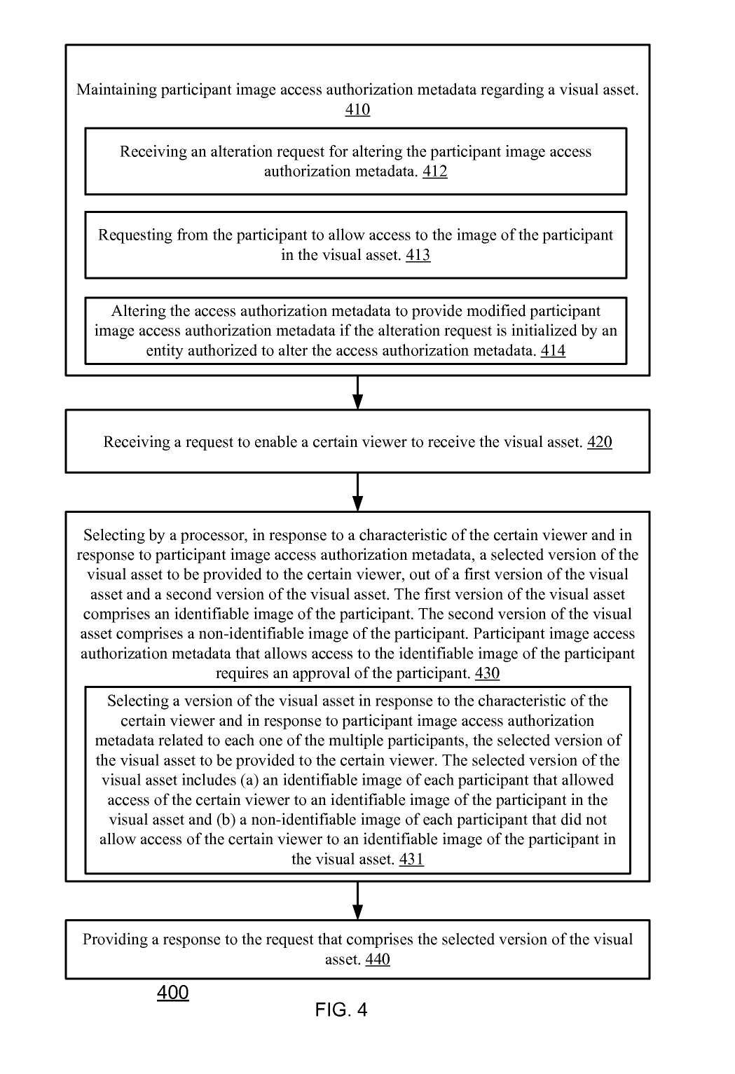

FIG. 4 illustrates a method 400 for controlled distribution of a content of a visual asset that comprises an image of a participant, according to an embodiment of the invention.

Method 400 may start by stage 410 of maintaining participant image access authorization metadata regarding a visual asset.

Stage 410 may be followed by stage 420 of receiving a request to enable a certain viewer to receive the visual asset.

Stage 420 may be followed by stage 430 of selecting by a processor, in response to a characteristic of the certain viewer and in response to participant image access authorization metadata, a selected version of the visual asset to be provided to the certain viewer, out of a first version of the visual asset and a second version of the visual asset. The first version of the visual asset comprises an identifiable image of the participant. The second version of the visual asset comprises a non-identifiable image of the participant. Participant image access authorization metadata that allows access to the identifiable image of the participant requires an approval of the participant.

The characteristic of the certain viewer may be an identity of the certain viewer. The identity of the viewer can be classified to one out of a participant, an owner and a third party but this is not necessarily so.

Stage 430 may include selecting the second version of the visual asset if at a point of time of the selecting the certain viewer was not authorized to view the identifiable image of the participant.

Stage 430 may include selecting the first version of the visual asset if the certain requester is an owner of the visual asset.

Stage 430 may be followed by stage 440 of providing a response to the request that comprises the selected version of the visual asset.

Stage 440 may include generating the selected version of the visual asset in response to the selecting of the selected version of the visual asset. This may include image processing the visual asset to generate the selected version. The generation may include converting an identifiable image of a participant to a non-identifiable image of the participant if the viewer should not receive the identifiable image of the participant—this can be done by masking, filtering, reducing the resolution of the identifiable image, or applying and manipulation process to generate the non-identifiable image of the participant.

Stage 440 may include retrieving from a memory module the selected version of the visual asset in response to the selecting of the selected version of the visual asset.

The participant image access authorization metadata can be changed over time. Accordingly, stage 410 may include stage 412 of receiving an alteration request for altering the participant image access authorization metadata. Stage 412 may be followed by stage 414 of altering the access authorization metadata to provide modified participant image access authorization metadata if the alteration request is initialized by an entity authorized to alter the access authorization metadata.

It is notices that when receiving a new request to enable the certain viewer to receive the visual asset, stage 430 may include selecting by the computer, in response to the characteristic of the certain viewer and in response to the modified participant image access authorization metadata, a new selected version of the visual asset to be provided to the certain viewer out of the first version of the visual asset and the second version of the visual asset.

According to an embodiment of the invention the visual asset may include images of multiple participants. Stage 430 may include stage 431 of selecting a version of the visual asset in response to the characteristic of the certain viewer and in response to participant image access authorization metadata related to each one of the multiple participants, the selected version of the visual asset to be provided to the certain viewer; wherein the selected version of the visual asset includes (a) an identifiable image of each participant that allowed access of the certain viewer to an identifiable image of the participant in the visual asset and (b) a non-identifiable image of each participant that did not allow access of the certain viewer to an identifiable image of the participant in the visual asset.

Stage 410 may also include stage 413 of requesting from the participant to allow access to the image of the participant in the visual asset. Stage 430 may include selectively allowing access to the image of the participant based upon an answer provided from the participant or a lack of an answer from the participant.

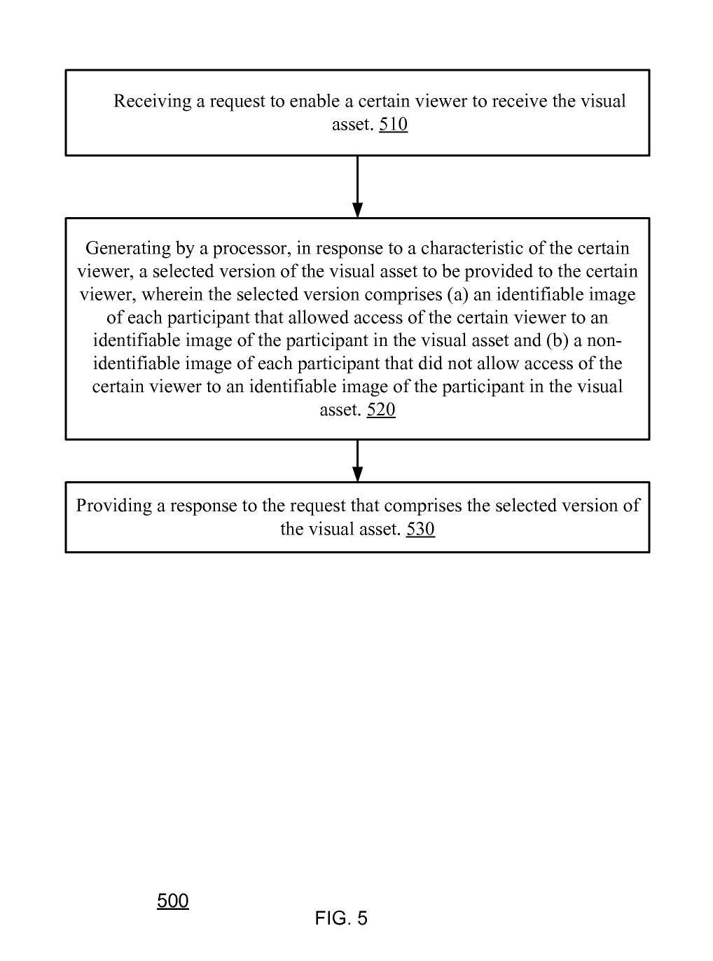

FIG. 5 illustrates a method 500 for controlled distribution of a content of a visual asset that includes images of multiple participants, according to an embodiment of the invention.

Method 500 may start by stage 510 of receiving a request to enable a certain viewer to receive the visual asset.

Stage 510 may be followed by stage 520 of generating by a processor, in response to a characteristic of the certain viewer, a selected version of the visual asset to be provided to the certain viewer, wherein the selected version comprises (a) an identifiable image of each participant that allowed access of the certain viewer to an identifiable image of the participant in the visual asset and (b) a non-identifiable image of each participant that did not allow access of the certain viewer to an identifiable image of the participant in the visual asset.

Stage 520 may include converting an identifiable image of a participant to a non-identifiable image of the participant if the viewer should not receive the identifiable image of the participant—this can be done by masking, filtering, reducing the resolution of the identifiable image, or applying and manipulation process to generate the non-identifiable image of the participant.

Stage 520 may be followed by stage 530 of providing a response to the request that comprises the selected version of the visual asset.

Stage 530 may include generating the selected version of the visual asset in response to the selecting of the selected version of the visual asset.

Stage 530 may include retrieving from a memory module the selected version of the visual asset in response to the selecting of the selected version of the visual asset.

The characteristic of the certain viewer may be an identity of the certain viewer.

Stage 530 may include allowing an owner of the visual asset to receive a selected version of the visual asset that comprises identifiable images of all the multiple participants.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for controlled distribution of a content of a visual asset that comprises an image of a participant, the method comprises:
receiving a request to enable a certain viewer to receive the visual asset;
selecting by a processor, in response to a characteristic of the certain viewer and in response to participant image access authorization metadata, a selected version of the visual asset to be provided to the certain viewer, out of a first version of the visual asset and a second version of the visual asset; wherein the first version of the visual asset comprises an identifiable image of the participant; wherein the second version of the visual asset comprises a non-identifiable image of the participant; wherein participant image access authorization metadata that allows access to the identifiable image of the participant requires an approval of the participant; and
providing a response to the request that comprises the selected version of the visual asset.

2. The method according to claim 1, comprising selecting the second version of the visual asset if at a point of time of the selecting the certain viewer was not authorized to view the identifiable image of the participant.

3. The method according to claim 1, comprising generating the selected version of the visual asset in response to the selecting of the selected version of the visual asset.

4. The method according to claim 1, comprising retrieving from a memory module the selected version of the visual asset in response to the selecting of the selected version of the visual asset.

5. The method according to claim 1, wherein the characteristic of the certain viewer is an identity of the certain viewer.

6. The method according to claim 1, comprising selecting the first version of the visual asset if the certain requester is an owner of the visual asset.

7. The method according to claim 1, comprising:
receiving an alteration request for altering the participant image access authorization metadata;
altering the access authorization metadata to provide modified participant image access authorization metadata if the alteration request is initialized by an entity authorized to alter the access authorization metadata;
receiving a new request to enable the certain viewer to receive the visual asset; and
selecting by the computer, in response to the characteristic of the certain viewer and in response to the modified participant image access authorization metadata, a new selected version of the visual asset to be provided to the certain viewer out of the first version of the visual asset and the second version of the visual asset.

8. The method according to claim 1, wherein the visual asset comprises images of multiple participants; and wherein the selecting comprises:
selecting a version of the visual asset in response to the characteristic of the certain viewer and in response to participant image access authorization metadata related to each one of the multiple participants, the selected version of the visual asset to be provided to the certain viewer;
wherein the selected version of the visual asset comprises (a) an identifiable image of each participant that allowed access of the certain viewer to an identifiable image of the participant in the visual asset and (b) a non-identifiable image of each participant that did not allow access of the certain viewer to an identifiable image of the participant in the visual asset.

9. The method according to claim 1, comprising requesting from the participant to allow access to the image of the participant in the visual asset; and selectively allowing access to the image of the participant based upon an answer provided from the participant or a lack of an answer from the participant.

10. A method for controlled distribution of a content of a visual asset that comprises images of multiple participants, the method comprises:
receiving a request to enable a certain viewer to receive the visual asset;
generating by a processor, in response to a characteristic of the certain viewer, a selected version of the visual asset to be provided to the certain viewer, wherein the selected version comprises (a) an identifiable image of each participant that allowed access of the certain viewer to an identifiable image of the participant in the visual asset and (b) a non-identifiable image of each participant that did not allow access of the certain viewer to an identifiable image of the participant in the visual asset; and
providing a response to the request that comprises the selected version of the visual asset.

11. The method according to claim 10, comprising generating the selected version of the visual asset in response to the selecting of the selected version of the visual asset.

12. The method according to claim 10, comprising retrieving from a memory module the selected version of the visual asset in response to the selecting of the selected version of the visual asset.

13. The method according to claim 10, wherein the characteristic of the certain viewer is an identity of the certain viewer.

14-42. (canceled)
